(19) United States
(12) Patent Application Publication
(10) Pub. No.: US 2025/0023753 A1
(43) Pub. Date: Jan. 16, 2025

(54) THERMOSTAT CONFIGURATION AND CONTROL

(71) Applicant: Ademco Inc., Golden Valley, MN (US)

(72) Inventors: Alejandro Arana, Chihuahua (MX); Andrea Mariana Martinez, Chihuahua (MX); Victor David Carreon, Juarez (MX); Daniel Alejandro Navarrete, Chihuahua (MX)

(73) Assignee: Ademco Inc., Golden Valley, MN (US)

(21) Appl. No.: 18/712,919

(22) PCT Filed: Nov. 24, 2021
(86) PCT No.: PCT/US2021/060682

§ 371 Date: May 23, 2024

(51) Int. Cl. H04L 12/28

(52) U.S. Cl. CPC H04L 12/2807; H04L 12/282; H04L 2012/2841

(57) ABSTRACT

Techniques herein disclose a method for initializing a home automation device using near-field communication and a separate computing device. The computing device receives a request to initialize a home automation device. The computing device receives an indication of one or more initialization settings for the home automation device. The computing device installs the one or more initialization settings onto the home automation device by sending the one or more initialization settings to the home automation device using near-field communication.

### TECHNICAL FIELD

The present disclosure relates generally to home automation devices, including heating, ventilation, and/or air conditioning (HVAC) controllers.

### BACKGROUND

Various smart home devices, including home automation devices such as thermostats, humidifiers, lighting systems, and appliances, among other things, are typically quite complicated to initially set up. Often times the user interface of the device is designed for optimally performing the specific tasks of the device, but that same interface can be tedious and cumbersome when configuring initial settings for the device. For instance, many thermostats are not designed to have accessible keyboards for entering wireless internet networks and passwords or for configuring operation schedules for the device, meaning a user will have to rotate an outer bezel of the thermostat to reach different characters. This difficulty is compounded in homes with multiple different types of devices, or in buildings with multiple HVAC zones that are each controlled by separate thermostats, as the user must use clunky interfaces to set up each and every device in the building. Furthermore, these home automation devices must typically be charged or connected to power prior to being configured, reducing the flexibility in the installation process.

### SUMMARY

In general, the disclosure is directed to techniques for using radio-frequency identification (RFID) and near-field communication (NFC) protocols to quickly install settings, whether they be initialization settings or operational settings, onto a home automation device. A user may utilize any RFID- or NFC-enabled mobile device, such as a smartphone or a tablet computer, to configure the various settings on the mobile device where the interface and tools available to the mobile device are more conducive for longer, manual inputs. Once one or more settings are configured, the mobile device is brought within a particular range of the home automation device such that the two devices can communicate over the RFID or NFC protocol. The mobile device sends the various settings to the home automation device over the RFID or NFC protocol, allowing the home automation device to be configured with minimal input on the home automation device itself.

These benefits can be compounded in the same situation where previous problems in the technology were compounded. Using the techniques described herein, a user can define the settings on a mobile device once and use those same settings on multiple different devices. As such, when a user is installing multiple thermostats in different zones of a same building, a user can simply enter the settings on the mobile device one time and use RFID or NFC communication to send those settings to each thermostat without having to re-enter the settings or go through tedious walkthroughs that ask for the same information. Additionally, in the instances where NFC communication is used, antenna loops in the mobile device and the home automation device can send small amounts of electric current between one another. As such, for home automation devices that are not charged or not connected to power, the NFC communication can include enough electrical current to store and potentially even implement the settings received in the NFC communication. This means that a user can transfer the settings from the mobile device to the home automation device with the home automation device being fresh out of the box, without installing the home automation device, meaning that the home automation device can begin executing according to those settings the instant it is installed in place.

One embodiment includes a method comprising receiving, by a computing device, a request to initialize a home automation device. The method further comprises receiving, by the computing device, an indication of one or more initialization settings for the home automation device. The method also comprises installing, by the computing device, the one or more initialization settings onto the home automation device by sending the one or more initialization settings to the home automation device using near-field communication.

In a further embodiment of the method, installing the one or more initialization settings onto the home automation device further comprises activating, by the computing device, a loop antenna in the computing device and transmitting, by the loop antenna in the computing device, and through inductive coupling, an electrical current to a loop antenna in the home automation device.

In a further embodiment of the method, receiving the request to initialize the home automation device comprises one or more of receiving, by the computing device, an indication of user input selecting an initialize option within an application installed on the computing device, and receiving, by the computing device, an indication of user input to run the application installed on the computing device.

In a further embodiment of the method, the method further comprises, without receiving a second request to initialize a second home automation device, installing, by the computing device, the one or more initialization settings onto the second home automation device by sending the one or more initialization settings to the second home automation device using near-field communication.

In a further embodiment of the method, the method further comprises controlling, by the computing device, the home automation device by sending one or more operational instructions to the home automation device using near-field communication.

In one such example of this further embodiment, the method further comprises, prior to controlling the home automation device, receiving, by the computing device, an indication of user input defining the one or more operational instructions.

In a further embodiment of the method, the one or more initialization settings comprise one or more of a device label, a location indication, a backlight setting, an operation schedule, installer setup files, one or more operation restrictions, one or more operational instructions, one or more sensor settings, and an internet connection.

In one such example of this further embodiment, the one or more operational instructions comprise one or more of a power setting, a temperature setting, a safety temperature setting, a unit setting, a humidity control setting, a machine learning setting, a light setting, an efficiency setting, a home/away setting, a cooling/heating mode, a volume setting, an input mode setting, a channel setting, a voice control setting, a camera setting, a lock setting, a color setting, and a directional setting.

Another embodiment includes a method comprising receiving, by a computing device, a request to control a thermostat device. The method further comprises receiving, by the computing device, an indication of one or more operational instructions for the thermostat device. The method also comprises controlling, by the computing device, the thermostat device by sending the one or more operational instructions to the thermostat device using near-field communication.

In a further embodiment of the method, the one or more operational instructions comprise one or more initialization settings, and controlling the thermostat device comprises installing, by the computing device, the one or more initialization settings onto the thermostat device by sending the one or more initialization settings to the thermostat device using near-field communication.

In one such example of this further embodiment, the one or more initialization settings comprise one or more of a device label, a location indication, a backlight setting, an operation schedule, installer setup files, one or more operation restrictions, one or more sensor settings, and an internet connection.

In another example of this further embodiment, controlling the thermostat device further comprises activating, by the computing device, a loop antenna in the computing device and transmitting, by the loop antenna in the computing device, and through inductive coupling, an electrical current to a loop antenna in the thermostat device.

In yet another example of this further embodiment, receiving the request to control the thermostat device comprises one or more of receiving, by the computing device, an indication of user input selecting a control option within an application installed on the computing device, and receiving, by the computing device, an indication of user input to run the application installed on the computing device.

In still another example of this further embodiment, the method further comprises, without receiving a second request to control a second thermostat device, controlling, by the computing device, the second thermostat device by sending the one or more operational instructions to the second thermostat device using near-field communication.

In another example of this further embodiment, the one or more operational instructions comprise one or more of a power setting, a temperature setting, a safety temperature setting, a unit setting, a humidity control setting, a machine learning setting, a light setting, an efficiency setting, a home/away setting, and a cooling/heating mode.

Another embodiment includes a system comprising a home automation device comprising a first loop antenna and a computing device comprising a second loop antenna and one or more processors. The one or more processors are configured to receive a request to initialize the home automation device. The one or more processors are further configured to receive an indication of one or more initialization settings for the home automation device. The one or more processors are also configured to install the one or more initialization settings onto the home automation device by sending the one or more initialization settings to the home automation device using near-field communication.

In a further embodiment of the system, to install the one or more initialization settings onto the home automation device, the second loop antenna is configured to activate and transmit, through inductive coupling, an electrical current to the first loop antenna in the home automation device.

In a further embodiment of the system, the one or more processors are further configured to, without receiving a second request to initialize a second home automation device, install the one or more initialization settings onto the second home automation device by sending the one or more initialization settings to the second home automation device using near-field communication.

In a further embodiment of the system, the one or more processors are further configured to control the home automation device by sending one or more operational instructions to the home automation device using near-field communication.

In a further embodiment of the system, the home automation device comprises one or more of a thermostat device, a home security system, a refrigerator, a washing machine, a dishwasher, a clothes dryer, a camera, a speaker system, a television, a vacuum cleaner, and a light.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

The following drawings are illustrative of particular examples of the present invention and therefore do not limit the scope of the invention. The drawings are not necessarily to scale, though embodiments can include the scale illustrated, and are intended for use in conjunction with the explanations in the following detailed description wherein like reference characters denote like elements. Examples of the present invention will hereinafter be described in conjunction with the appended drawings.

FIG. 1 is a block diagram illustrating an example system for installing settings onto a home automation device, in accordance with some examples of this disclosure.

FIG. 2 is a block diagram illustrating a more detailed example of a computing device configured to perform the techniques described herein.

FIG. 3 is a conceptual diagram illustrating an example system for installing settings onto a home automation device, in accordance with some examples of this disclosure.

FIG. 4 is a flow diagram illustrating a method, in accordance with some examples of this disclosure.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

Radio-frequency identification (RFID) systems typically consist of a reader with an antenna, and a transponder (tag). There are two different RFID tags possible. Either they are active, meaning they have their own power source or they are passive. Passive tags have no own power source and have to be supplied with energy via an electromagnetic field produced by the reader. The reading range of the most common systems is only a few centimeters.

Near-field communication (NFC) is also based on the RFID protocols. The main difference to RFID is that a NFC device can act not only as a reader, but also as a tag when used in a card emulation mode. In peer-to-peer mode, it is also possible to transfer information between two NFC devices.

Passive tags are made out of a microchip and an antenna reader. The RFID tag receives the message and then responds with its identification and other information (user configuration). Due its storage capabilities, a reader can be used to write custom information in the tag, which can be later consumed by another device.

In accordance with one or more of the techniques described herein, information written in an RIFD or NFC tag can include thermostat (or other home automation device) configuration information, which can be later be read by the thermostat once the thermostat is connected to a power source. As loop antennas can transmit a small amount of power in addition to the custom tag, the thermostat does not need to be connected to the power source in order to receive the information. These readers can be found in smartphones and other mobile devices, so the user can write custom data to the tag.

Currently, certain home automation devices have the capability to control temperature by following a pre-defined schedule. This involves a high physical interaction between the user and the device, especially with the first time the user desires to configure the schedule settings. A similar effort would also be required for subsequent changes to the schedule settings. Setting this kind of configurations in a device which usually is attached to a wall can potentially be uncomfortable for the user, besides having to get used to a mechanical user interface instead of a well-known interface in a smartphone. This could avoid the necessity for the user to have a user manual on hand due to much more specific information could be shown in its mobile device than in the physical device, which can make the user experience much easier. In case of the installer setup configuration of the thermostat, the device may have a limited user interface that is annoying and confusing for the user to have to look every single time to the user manual and make the configuration.

A mobile device may download a mobile application to execute certain techniques described herein. This application may present all of the initial configurations for their specific equipment and may allow for the selection of the desired options for each. After the setup is completed on the mobile device, the user will only need to approach its thermostat and get their mobile device in the correct NFC range in order to initiate the communication between the two devices. After the data has been transferred, the thermostat and/or the mobile device may show a success message.

In general, the disclosure is directed to techniques for using RFID and NFC protocols to quickly install settings, whether they be initialization settings or operational settings, onto a home automation device. A user may utilize any RFID- or NFC-enabled mobile device, such as a smartphone or a tablet computer, to configure the various settings on the mobile device where the interface and tools available to the mobile device are more conducive for longer, manual inputs. Once one or more settings are configured, the mobile device is brought within a particular range of the home automation device such that the two devices can communicate over the RFID or NFC protocol. The mobile device sends the various settings to the home automation device over the RFID or NFC protocol, allowing the home automation device to be configured with minimal input on the home automation device itself.

These benefits can be compounded in the same situation where previous problems in the technology were compounded. Using the techniques described herein, a user can define the settings on a mobile device once and use those same settings on multiple different devices. As such, when a user is installing multiple thermostats in different zones of a same building, a user can simply enter the settings on the mobile device one time and use RFID or NFC communication to send those settings to each thermostat without having to re-enter the settings or go through tedious walkthroughs that ask for the same information. Additionally, in the instances where NFC communication is used, antenna loops in the mobile device and the home automation device can send small amounts of electric current between one another. As such, for home automation devices that are not charged or not connected to power, the NFC communication can include enough electrical current to store and potentially even implement the settings received in the NFC communication. This means that a user can transfer the settings from the mobile device to the home automation device with the home automation device being fresh out of the box, without installing the home automation device, meaning that the home automation device can begin executing according to those settings the instant it is installed in place.

These techniques include additional benefits. For instance, by having the settings pre-loaded onto the home automation device, the home automation device may consume less power overall in the setting installation phase. These techniques may also reduce hardware requirements and certifications needed for the home automation device. For future development of home automation devices, moving the interface to a mobile application may reduce development time, as user interfaces no longer need to be designed. This may reduce costs for future home automation devices and lead to an easier configuration experience for the user. For non-connected thermostats (i.e., thermostats without internet connection), the techniques described herein may enable synchronization across multiple non-connected devices.

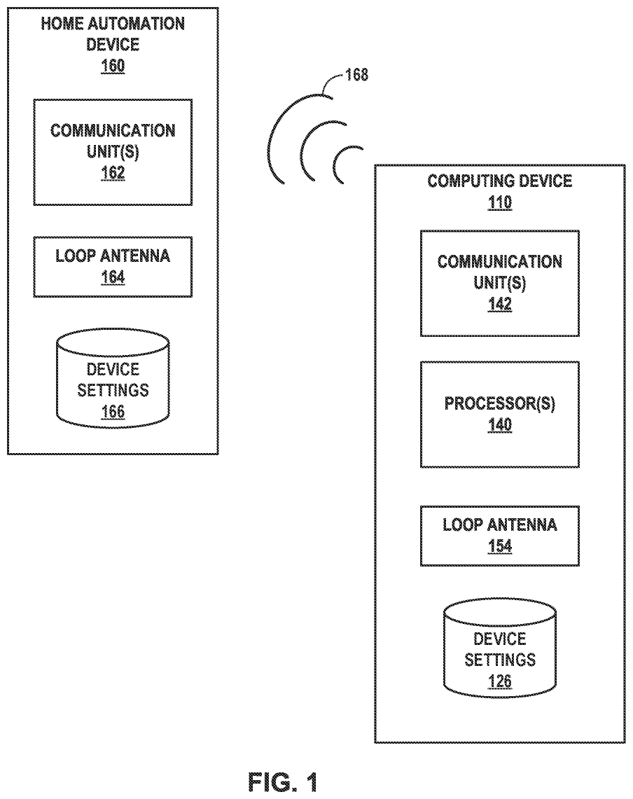

FIG. 1 is a block diagram illustrating an example system for installing settings onto home automation device 160, in accordance with some examples of this disclosure. In the example of FIG. 1, computing device 110 may be configured to transmit signal 168 to home automation device 160, with signal 168 including information stored in device settings database 126. Home automation device 160 may store that information from signal 168 in device settings database 166.

Computing device 110 may be any computer that is RFID- or NFC-enabled and with the processing power required to adequately execute the techniques described herein. For instance, computing device 210 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

Computing device 110 may include one or more communication units 142. One or more communication units 142 of computing device 110 may communicate with external devices via one or more wired and/or wireless networks by transmitting and/or receiving network signals on one or more networks. Examples of communication units 142 include a network interface card (e.g. such as an Ethernet card), an optical transceiver, a radio frequency transceiver, a GPS receiver, an RFID transceiver, an NFC transceiver, or any other type of device that can send and/or receive information. Other examples of communication units 142 may include short wave radios, cellular data radios, wireless network radios, as well as universal serial bus (USB) controllers.

One or more processors 140 may implement functionality and/or execute instructions associated with computing device 110 to configure device data in device settings database 126 and transmit that data to home automation device 160. That is, processors 140 may implement functionality and/or execute instructions associated with computing device 110 to configure settings on home automation device 160 utilizing NFC technology.

Computing device 110 may further include loop antenna 154. Loop antenna 154 may be configured to operate on a small device at a low frequency with large wavelengths. Loop antenna 154 may be an inductor with a large surface area relative to the size of computing device 110 (e.g., loop antenna 154 may cover 50% or more of the surface area of one surface of computing device 110). Loop antenna 154 may contain a wrapped coil of metallic wire that loops one or more times around a chip on which the metallic wire is installed. As such, the loop of wire around the material gives a strong magnetic field within the loop, with more loops equaling a stronger magnetic field. When loop antenna 154 is placed nearby an additional loop antenna (e.g., loop antenna 164 of home automation device 160), a small electric charge may be generated on the additional loop antenna as a result of the magnetic fields coming into close contact with one another (e.g., closer than 1 cm in many cases, although additional loops and stronger magnetic fields could increase that distance to as much as 2.5 cm or even larger). This magnetic field and the data transmitted between loop antennas 154 and 164 is illustrated as signal 168.

Home automation device 160 may include any device that could be placed in a smart home system, including thermostats, indoor motion sensors, outdoor motion sensors, door and window contact sensors, air vent dampers, smart doorbells, outdoor air sensors, outdoor infrared sensors, indoor infrared sensors, routers, mobile devices, a security device, a water heater, a water flow controller, a garage door controller, a motion passive infrared (PIR) sensor, a mini contact sensor, a key fob, a smoke detector, a glass break detector, a siren, a combined smoke detector and Carbon monoxide (CO) detector, an indoor siren, a flood sensor, a shock sensor, an outdoor siren, a CO detector, a wearable medical pendant, a wearable panic device, an occupancy sensor, and a keypad, among other things.

Home automation device 160 may include one or more communication units 162. One or more communication units 162 of home automation device 160 may communicate with external devices via one or more wired and/or wireless networks by transmitting and/or receiving network signals on one or more networks. Examples of communication units 162 include a network interface card (e.g. such as an Ethernet card), an optical transceiver, a radio frequency transceiver, a GPS receiver, an RFID transceiver, an NFC transceiver, or any other type of device that can send and/or receive information. Other examples of communication units 162 may include short wave radios, cellular data radios, wireless network radios, as well as universal serial bus (USB) controllers.

Home automation device 160 may further include loop antenna 164. Loop antenna 164 may be configured to operate on a small device at a low frequency with large wavelengths. Loop antenna 164 may be an inductor with a large surface area relative to the size of home automation device 160 (e.g., loop antenna 164 may cover 50% or more of the surface area of one surface of home automation device 160). Loop antenna 164 may contain a wrapped coil of metallic wire that loops one or more times around a chip on which the metallic wire is installed. As such, the loop of wire around the material gives a strong magnetic field within the loop, with more loops equaling a stronger magnetic field. When loop antenna 164 is placed nearby an additional loop antenna (e.g., loop antenna 154 of computing device 110), a small electric charge may be generated on the additional loop antenna as a result of the magnetic fields coming into close contact with one another (e.g., closer than 1 cm in many cases, although additional loops and stronger magnetic fields could increase that distance to as much as 2.5 cm or even larger). This magnetic field and the data transmitted between loop antennas 154 and 164 is illustrated as signal 168.

In accordance with the techniques described herein, computing device 110 may receive a request to initialize home automation device 160. Computing device 110 may further receive an indication of one or more initialization settings for home automation device 160, while storing those initialization settings in device settings database 126. Computing device 110 may install the one or more initialization settings onto home automation device 160 by sending the one or more initialization settings to home automation device 160 using near-field communication between communication units 142 and 162 and loop antennas 154 and 164.

In sending the one or more initialization settings to home automation device 160, loop antenna 154 and loop antenna 164 may create a small electric current on home automation device 160. This current may be enough such that home automation device 160 may store the one or more initialization settings in device settings database 166, even if home automation device 160 is not connected to an additional power source. This means that computing device 110 may configure home automation device 160 before home automation device 160 is even installed in the building. Once the user installs home automation device 160 and home automation device 160 is connected to a power source, home automation device 160 may retrieve the initialization settings from device settings database 166 and implement the initialization settings in operation.

Additionally, computing device 110 may repeat this process with additional home automation devices, potentially without updating the initialization settings originally input into computing device 110. As such, computing device 110 may receive a single instance of user input and configure as many home automation devices as necessary for the particular installation process. This will greatly reduce the user inputs provided to the devices in this system, thereby increasing the longevity and mechanical sustainability of those devices.

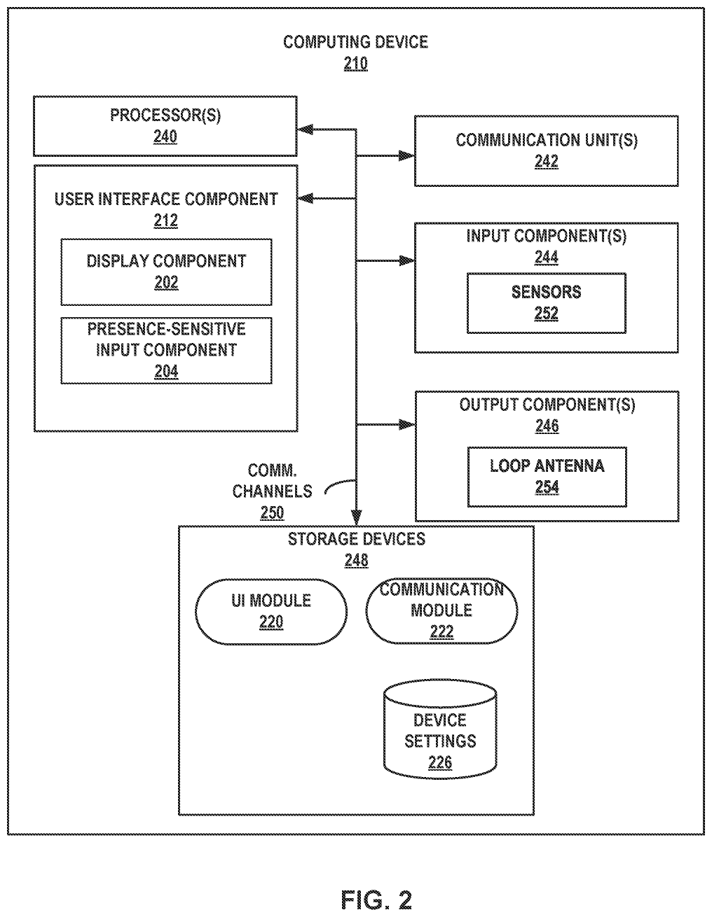

FIG. 2 is a block diagram illustrating an example computing device configured to determine a characteristic of received user input and output a corresponding set of sub-elements associated with an application on the computing device, in accordance with one or more aspects of the techniques described in this disclosure. Computing device 210 of FIG. 2 is described below as an example of computing device 110 of FIG. 1. FIG. 2 illustrates only one particular example of computing device 210, and many other examples of computing device 210 may be used in other instances and may include a subset of the components included in example computing device 210 or may include additional components not shown in FIG. 2.

Computing device 210 may be any RFID- or NFC-enabled computer with the processing power required to adequately execute the techniques described herein. For instance, computing device 210 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

As shown in the example of FIG. 2, computing device 210 includes user interface component (UIC) 212, one or more processors 240, one or more communication units 242, one or more input components 244, one or more output components 246, and one or more storage components 248. UIC 212 includes display component 202 and presence-sensitive input component 204. Storage components 248 of computing device 210 include UI module 220, communication module 222, and device settings data store 226.

One or more processors 240 may implement functionality and/or execute instructions associated with computing device 210 to receive initialization settings and transmit those initialization settings to a home automation device. That is, processors 240 may implement functionality and/or execute instructions associated with computing device 210 to configure one or more home automation devices with settings stored in device settings data store 226.

Examples of processors 240 include application processors, display controllers, auxiliary processors, one or more sensor hubs, and any other hardware configure to function as a processor, a processing unit, or a processing device. Modules 218, 220, 222, and 224 may be operable by processors 240 to perform various actions, operations, or functions of computing device 210. For example, processors 240 of computing device 210 may retrieve and execute instructions stored by storage components 248 that cause processors 240 to perform the operations described with respect to modules 220 and 222. The instructions, when executed by processors 240, may cause computing device 210 to configure one or more home automation devices with settings stored in device settings data store 226.

UI module 220 may execute locally (e.g., at processors 240) to provide functions associated with managing a user interface that computing device 210 provides at UIC 212 for example, for facilitating interactions between a user of computing device 210 and a home automation device. In some examples, UI module 220 may act as an interface to a remote service accessible to computing device 210. For example, UI module 220 may be an interface or application programming interface (API) to a remote server that facilitates communication between a user and an application executing on computing device 210 such that computing device 210 may configure a home automation device.

In some examples, communication module 222 may execute locally (e.g., at processors 240) to provide functions associated with transmitting the initialization settings stored in device settings data store 226 to a home automation device. In some examples, communication module 222 may act as an interface to a remote service accessible to computing device 210. For example, communication module 222 may be an interface or application programming interface (API) to a remote server that coordinates the transfer of the initialization settings to the home automation device.

One or more storage components 248 within computing device 210 may store information for processing during operation of computing device 210 (e.g., computing device 210 may store data accessed by modules 220 and 222 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220 and 222 and data store 226. Storage components 248 may include a memory configured to store data or other information associated with modules 220 and 222 and data store 226.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on one or more networks. Examples of communication units 242 include a network interface card (e.g. such as an Ethernet card), an optical transceiver, a radio frequency transceiver, a GPS receiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 244 of computing device 210, in one example, includes a presence-sensitive input device (e.g., a touch sensitive screen, a PSD), mouse, key board, voice responsive system, camera, microphone or any other type of device for detecting input from a human or machine. In some examples, input components 244 may include one or more sensor components (e.g., sensors 252). Sensors 252 may include one or more biometric sensors (e.g., fingerprint sensors, retina scanners, vocal input sensors/microphones, facial recognition sensors, cameras) one or more location sensors (e.g., GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a heart rate sensor, magnetometer, glucose sensor, olfactory sensor, compass sensor, or a step counter sensor.

One or more output components 246 of computing device 210 may generate output in a selected modality. Examples of modalities may include a tactile notification, audible notification, visual notification, machine generated voice notification, or other modalities. Output components 246 of computing device 210, in one example, includes a presence-sensitive display, a sound card, a video graphics adapter card, a speaker, a cathode ray tube (CRT) monitor, a liquid crystal display (LCD), a light emitting diode (LED) display, an organic LED (OLED) display, a virtual/augmented/extended reality (VR/AR/XR) system, a three-dimensional display, or any other type of device for generating output to a human or machine in a selected modality.

UIC 212 of computing device 210 may include display component 202 and presence-sensitive input component 204. Display component 202 may be a screen, such as any of the displays or systems described with respect to output components 246, at which information (e.g., a visual indication) is displayed by UIC 212 while presence-sensitive input component 204 may detect an object at and/or near display component 202.

While illustrated as an internal component of computing device 210, UIC 212 may also represent an external component that shares a data path with computing device 210 for transmitting and/or receiving input and output. For instance, in one example, UIC 212 represents a built-in component of computing device 210 located within and physically connected to the external packaging of computing device 210 (e.g., a screen on a mobile phone). In another example, UIC 212 represents an external component of computing device 210 located outside and physically separated from the packaging or housing of computing device 210 (e.g., a monitor, a projector, etc. that shares a wired and/or wireless data path with computing device 210).

UIC 212 of computing device 210 may detect two-dimensional and/or three-dimensional gestures as input from a user of computing device 210. For instance, a sensor of UIC 212 may detect a user's movement (e.g., moving a hand, an arm, a pen, a stylus, a tactile object, etc.) within a threshold distance of the sensor of UIC 212. UIC 212 may determine a two or three-dimensional vector representation of the movement and correlate the vector representation to a gesture input (e.g., a hand-wave, a pinch, a clap, a pen stroke, etc.) that has multiple dimensions. In other words, UIC 212 can detect a multi-dimension gesture without requiring the user to gesture at or near a screen or surface at which UIC 212 outputs information for display. Instead, UIC 212 can detect a multi-dimensional gesture performed at or near a sensor which may or may not be located near the screen or surface at which UIC 212 outputs information for display.

Computing device 210 may further include loop antenna 254. Loop antenna 254 may be configured to operate on a small device at a low frequency with large wavelengths. Loop antenna 254 may be an inductor with a large surface area relative to the size of computing device 210 (e.g., loop antenna 254 may cover 50% or more of the surface area of one surface of computing device 210). Loop antenna 254 may contain a wrapped coil of metallic wire that loops one or more times around a chip on which the metallic wire is installed. As such, the loop of wire around the material gives a strong magnetic field within the loop, with more loops equaling a stronger magnetic field. When loop antenna 254 is placed nearby an additional loop antenna (e.g., a loop antenna of a home automation device), a small electric charge may be generated on the additional loop antenna as a result of the magnetic fields coming into close contact with one another (e.g., closer than 1 cm in many cases, although additional loops and stronger magnetic fields could increase that distance to as much as 2.5 cm or even larger).

In accordance with the techniques described herein, UI module 220 receives a request to initialize a home automation device (e.g., a thermostat device, a home security system, a refrigerator, a washing machine, a dishwasher, a clothes dryer, a camera, a speaker system, a television, a vacuum cleaner, and a light, among other things). In some instances, UI module 220 may receive this request from the home automation device. In other instances, UI module 220 may interact with an application installed on computing device 210. For example, UI module 220 may receive an indication of user input selecting an initialize option within an application installed on computing device 210. Other examples of UI module 220 interacting with an application include UI module 220 receiving an indication of user input to run the application installed on computing device 210.

UI module 220 may receive an indication of one or more initialization settings for the home automation device and store these initialization settings in device settings data store 226. Examples of initialization settings include a device label, a location indication, a backlight setting, an operation schedule, installer setup files, one or more operation restrictions, one or more operational instructions, one or more sensor settings, an internet connection, or any other setting that may typically be set during the initial set up or configuration of a home automation device.

Operational instructions can include post-installation or post-setup settings that the home automation device may implement during the operation of the home automation device. For instance, the one or more operational instructions may include a power setting, a temperature setting, a safety temperature setting, a unit setting, a humidity control setting, a machine learning setting, a light setting, an efficiency setting, a home/away setting, a cooling/heating mode, a volume setting, an input mode setting, a channel setting, a voice control setting, a camera setting, a lock setting, a color setting, and a directional setting. Even after the initial setup, though, other initialization settings may be altered in this manner.

Communication module 222 installs the one or more initialization settings onto the home automation device by sending the one or more initialization settings to the home automation device using near-field communication via communication units 242 and/or loop antenna 254. For instance, communication module 222 may activate loop antenna 254 in computing device 210 and transmit, through inductive coupling, an electrical current to a loop antenna in the home automation device. This electrical current in the home automation device may power the home automation device enough that the home automation device may store the received initialization settings locally until the home automation device is installed and connected to a power source, at which time the home automation device may implement the received initialization settings. However, the techniques described herein are also applicable to home automation devices that are connected to power sources and already in operation. In other words, these techniques may also be used to update previously installed settings on home automation devices.

Computing device 210 may use the same initialization settings to initially set up (or update) multiple home automation devices without having to re-enter those initialization settings or have additional user input. For instance, without receiving a second request to initialize a second home automation device, communication module 222 may install the one or more initialization settings onto the second home automation device by sending the one or more initialization settings to the second home automation device using near-field communication via communication units 242 and/or loop antenna 254.

Communication module 222 may further control the home automation device by sending one or more operational instructions (or one or more other initialization settings) to the home automation device using near-field communication via communication units 242 and/or loop antenna 254. In some instances, prior to controlling the home automation device, UI module 220 may receive an indication of user input defining the one or more operational instructions in a similar manner as UI module 220 received the initial set of one or more initialization settings.

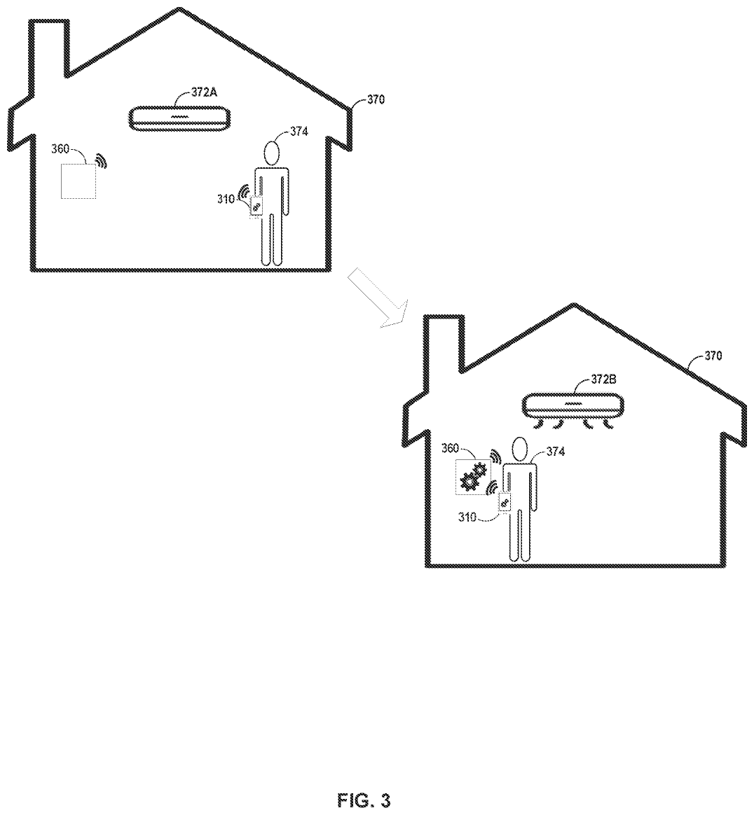

FIG. 3 is a conceptual diagram illustrating an example system for installing settings onto a home automation device, in accordance with some examples of this disclosure. FIG. 3 includes building 370, which may be a home, an industrial building, or a commercial building. User 374 may wish to configure thermostat 360 using mobile device 310.

Mobile device 310, possibly executing a special application designed to prompt the user for particular initialization settings, may receive user input defining the initialization settings to be used for the initial set up of thermostat 360. Initially, thermostat 360 may not be operational. For instance, thermostat 360 may be freshly out of the box and not connected to a power source, or thermostat 360 may be physically installed on a wall of building 370 and connected to a power source but not yet initialized. As such, HVAC system 372A may not be expelling air or adjusting a climate within building 370.

As user 374, with the initialization settings entered into mobile device 310, approaches thermostat 360, mobile device 310 may come within a particular range of thermostat 360 such that NFC is enabled (i.e., such that a loop antenna in mobile device 310 produces a magnetic field that is strong enough to generate an electrical current in a loop antenna of thermostat 360, such as within 1 cm). Using NFC, mobile device 310 may install the initialization settings onto thermostat 360. If thermostat 360 is not yet connected to a power source, the electrical current generated by the loop antennas may be enough that thermostat 360 may store the initialization settings locally until thermostat 360 is properly installed.

Once thermostat 360 has received the initialization settings from mobile device 310 and once thermostat 360 is properly installed and connected to a power source, HVAC 372B may be operational. If the schedule installed on thermostat 360 indicated that HVAC 372B should begin adjusting the climate inside of building 370, HVAC 372B may begin expelling air.

User 374 may repeat this process, even after thermostat 360 has been installed and initialized, to update the settings on thermostat 360. For instance, user 374 may input various updates to the initialization settings and/or operating instructions into mobile device 310. Using NFC, mobile device 310 may transmit those updated settings to thermostat 360, which implements the updated initialization settings and/or operating instructions.

Additionally, user 374 may repeat this process with additional thermostat devices. For instance, building 370 may be a multi-zone commercial building, such as a shopping mall or an office building. When initially installing the thermostats, after user 374 and mobile device 310 initializes thermostat 360, user 374 may bring mobile device 310 directly to within NFC range of the additional thermostat devices without altering the settings defined on mobile device 310. This would greatly increase the efficiency at which a single user could install multiple home automation devices in a single building.

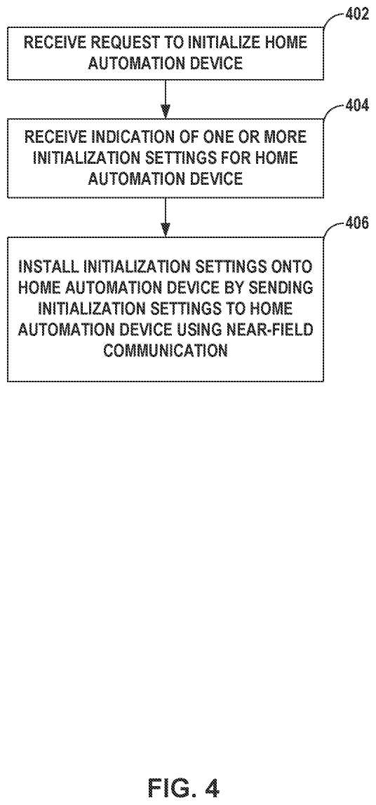

FIG. 4 is a flow diagram illustrating a method, in accordance with some examples of this disclosure. The techniques of FIG. 4 may be performed by one or more processors of a computing device, such as computing device 110 of FIG. 1 and/or computing device 210 illustrated in FIG. 2. For purposes of illustration only, the techniques of FIG. 4 are described within the context of computing device 210 of FIG. 2, although computing devices having configurations different than that of computing device 210 may perform the techniques of FIG. 4.

UI module 220 receives a request to initialize a home automation device (402), such as a thermostat. UI module 220 further receives an indication of one or more initialization settings for the home automation device (404). Communication module 222 installs the one or more initialization settings onto the home automation device by sending the one or more initialization settings to the home automation device using near-field communication (406).

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples of the disclosure have been described. Any combination of the described systems, operations, or functions is contemplated. These and other examples are within the scope of the following claims.

What is claimed is:

1. A method comprising:
receiving, by a computing device, a request to initialize a home automation device;
receiving, by the computing device, an indication of one or more initialization settings for the home automation device; and
installing, by the computing device, the one or more initialization settings onto the home automation device by sending the one or more initialization settings to the home automation device using near-field communication.

2. The method of claim 1, wherein installing the one or more initialization settings onto the home automation device further comprises:
activating, by the computing device, a loop antenna in the computing device; and
transmitting, by the loop antenna in the computing device, and through inductive coupling, an electrical current to a loop antenna in the home automation device.

3. The method of claim 1, wherein receiving the request to initialize the home automation device comprises one or more of:
receiving, by the computing device, an indication of user input selecting an initialize option within an application installed on the computing device, and
receiving, by the computing device, an indication of user input to run the application installed on the computing device.

4. The method of claim 1, further comprising:
without receiving a second request to initialize a second home automation device, installing, by the computing device, the one or more initialization settings onto the second home automation device by sending the one or more initialization settings to the second home automation device using near-field communication.

5. The method of claim 1, further comprising:
controlling, by the computing device, the home automation device by sending one or more operational instructions to the home automation device using near-field communication.

6. The method of claim 5, further comprising:
prior to controlling the home automation device, receiving, by the computing device, an indication of user input defining the one or more operational instructions.

7. The method of claim 1, wherein the one or more initialization settings comprise one or more of:
a device label,
a location indication,
a backlight setting,
an operation schedule,
installer setup files,
one or more operation restrictions,
one or more operational instructions,
one or more sensor settings, and
an internet connection.

8. The method of claim 7, wherein the one or more operational instructions comprise one or more of:
a power setting,
a temperature setting,
a safety temperature setting,
a unit setting,
a humidity control setting,
a machine learning setting,
a light setting,
an efficiency setting,
a home/away setting,
a cooling/heating mode,
a volume setting,
an input mode setting,
a channel setting,
a voice control setting,
a camera setting,
a lock setting,
a color setting, and
a directional setting.

9. A method comprising:
receiving, by a computing device, a request to control a thermostat device;
receiving, by the computing device, an indication of one or more operational instructions for the thermostat device; and
controlling, by the computing device, the thermostat device by sending the one or more operational instructions to the thermostat device using near-field communication.

10. The method of claim 9, wherein the one or more operational instructions comprise one or more initialization settings, and wherein controlling the thermostat device comprises:
installing, by the computing device, the one or more initialization settings onto the thermostat device by sending the one or more initialization settings to the thermostat device using near-field communication.

11. The method of claim 10, wherein the one or more initialization settings comprise one or more of:
a device label,
a location indication,
a backlight setting,
an operation schedule,
installer setup files,
one or more operation restrictions,
one or more sensor settings, and
an internet connection.

12. The method of claim 10, wherein controlling the thermostat device further comprises:
activating, by the computing device, a loop antenna in the computing device; and
transmitting, by the loop antenna in the computing device, and through inductive coupling, an electrical current to a loop antenna in the thermostat device.

13. The method of claim 10, wherein receiving the request to control the thermostat device comprises one or more of:
receiving, by the computing device, an indication of user input selecting a control option within an application installed on the computing device, and
receiving, by the computing device, an indication of user input to run the application installed on the computing device.

14. The method of claim 10, further comprising:
without receiving a second request to control a second thermostat device, controlling, by the computing device, the second thermostat device by sending the one or more operational instructions to the second thermostat device using near-field communication.

15. The method of claim 10, wherein the one or more operational instructions comprise one or more of:
a power setting,
a temperature setting,
a safety temperature setting,
a unit setting,
a humidity control setting,
a machine learning setting,
a light setting,
an efficiency setting,
a home/away setting, and
a cooling/heating mode.

16. A system comprising:
a home automation device comprising a first loop antenna; and
a computing device comprising a second loop antenna and one or more processors, wherein the one or more processors are configured to:
receive a request to initialize the home automation device;
receive an indication of one or more initialization settings for the home automation device; and
install the one or more initialization settings onto the home automation device by sending the one or more initialization settings to the home automation device using near-field communication.

17. The system of claim 16, wherein, to install the one or more initialization settings onto the home automation device:
the second loop antenna is configured to activate and transmit, through inductive coupling, an electrical current to the first loop antenna in the home automation device.

18. The system of claim 16, wherein the one or more processors are further configured to:
without receiving a second request to initialize a second home automation device, install the one or more initialization settings onto the second home automation device by sending the one or more initialization settings to the second home automation device using near-field communication.

19. The system of claim 16, wherein the one or more processors are further configured to:
control the home automation device by sending one or more operational instructions to the home automation device using near-field communication.

20. The system of claim 16, wherein the home automation device comprises one or more of:
a thermostat device,
a home security system,
a refrigerator,
a washing machine,
a dishwasher,
a clothes dryer,
a camera,
a speaker system,
a television,
a vacuum cleaner, and
a light.
